(19) United States
(12) Patent Application Publication
(10) Pub. No.: US 2024/0318799 A1
(43) Pub. Date: Sep. 26, 2024

(54) MOTOR VEHICLE DEVICE FOR LIGHTING THE ROAD

(71) Applicant: VALEO VISION, Bobigny Cedex (FR)

(72) Inventor: Sylvain GIRAUD, Bobigny (FR)

(73) Assignee: VALEO VISION, Bobigny (FR)

(21) Appl. No.: 18/262,506

(22) PCT Filed: Jan. 28, 2022
(86) PCT No.: PCT/EP2022/052105

§ 371 Date: Jul. 21, 2023

(30) Foreign Application Priority Data
Jan. 29, 2021 (FR) 2100871

(51) Int. Cl. F21S 41/25; F21S 41/32

(52) U.S. Cl. CPC F21S 41/25; F21S 41/321

(57) ABSTRACT

The invention relates to a motor vehicle lighting device for lighting the road, including at least one light module. The at least one light module includes a light source and a collector with the collector having a reflective surface configured to collect and reflect the light beam. A lens associated with the at least one light module, configured to project the light beam reflected by the collector of the at least one light module, to form on the road an image of the reflective surface of the collector of the at least one light module. The lens extending in a horizontal direction substantially inclined with respect to the at least one light module. The lens having a horizontal focal point and a vertical focal point, with the horizontal focal point being offset with respect to the vertical focal point.

### TECHNICAL FIELD

The subject matter of the invention is a lighting device for a motor vehicle.

The invention relates to the technical field of lighting devices for motor vehicles, and more specifically to lighting devices comprising an inclined lens.

### BACKGROUND OF THE INVENTION

In the field of motor vehicle lighting, it is generally known practice to use lighting devices comprising at least one light module comprising a light source, a collector with a reflective surface, the lighting device comprising an optical projection system of lens type, the common lens imaging the reflective surface of the collector to form a light beam having an upper cut-off. The type of lens used is convex in a vertical plane and neutral in a horizontal plane, which means that in the vertical plane, said lens has a line of focus the curvature of which follows the curve of said lens. This line of focus is usually placed at the rear edge of the collector, such that the upper cut-off of the light beam formed from the images of the reflective surface of the collector by the lens is produced by this rear edge.

However, this type of lighting device has a drawback when the lens is positioned at an angle relative to the light module, which may be the case when a particular esthetic appearance of the lighting device is desired. To be specific, when the lighting device comprises a plurality of light modules, some light modules are closer to the common lens than others. In other words, the line of focus necessarily diverges from the rear edges of the collectors of some modules. For these modules, the image of the reflective surface of their collector by the common lens is therefore not sharp, which results in blurring in the cut-off formed in the light beam from the rear edge of this collector. This is because the further the collector is from the line of focus, the more the cut-off line of the light beam reflected by said collector is blurred, in particular in a direction opposite to the inclination of the common lens with respect to the light modules. Moreover, it is not possible to overcome this drawback by repositioning the collectors so as to position their rear edge on the line of focus, since there is generally little space behind the lighting device.

Similarly, in the case of a single light module, the angled position of the lens moves the line of focus away from part of the rear edge of the collector, referred to as the remote part. Consequently, a portion of the cut-off formed from this remote part of the rear edge appears blurred, which is detrimental to the quality of the beam.

One aim of the invention is to propose a lighting device making it possible to preserve the sharpness of the cut-off formed in a light beam produced by the image of the reflective surface of the collector of at least one light module from a lens, including when this lens has a significant inclination with respect to this light module.

### SUMMARY OF THE INVENTION

The subject matter of the invention is a motor vehicle lighting device for lighting the road, comprising at least one light module, the or each light module comprising a light source capable of emitting a light beam and a collector comprising a reflective surface configured to collect and reflect the light beam emitted by said light source; a lens associated with the light module or with each light module, configured to project the light beam reflected by the collector of the or each light module, said lens being configured to form on the road an image of the reflective surface of the collector of the or each light module; the lens extending in a substantially horizontal direction, the substantially horizontal direction being substantially inclined with respect to the light module(s).

The device is noteworthy in that the lens has a horizontal focal point and a vertical focal point, the horizontal focal point being offset with respect to the vertical focal point. In the remainder of the description, focal point, whether horizontal or vertical, will mean an objective focal point of the lens.

Advantageously, the motor vehicle lighting device for lighting the road comprises a plurality of light modules arranged adjacent to one another in a horizontal direction, each light module comprising a light source capable of emitting a light beam and a collector comprising a reflective surface configured to collect and reflect the light beam emitted by said light source; the lens being a lens common to the plurality of light modules, configured to project the light beam reflected by the collector of each light module, said common lens being configured to form on the road an image of the reflective surface of the collector of each light module; the common lens extending in a substantially horizontal direction, substantially inclined with respect to the light modules. In other words, the light modules are arranged adjacent on the same line and in a substantially horizontal direction. The term “substantially horizontal” means a direction parallel to the horizontal direction plus or minus 10 degrees. Preferably, each light source is arranged opposite the corresponding collector, in such a way that the reflective surface of said collector collects and reflects the light beam emitted by said corresponding light source.

By virtue of the invention, it is thus possible to perform light functions in which the cut-off formed by the image of the reflective surface of the collector or of each collector is sharp. Therefore, it is possible to use a lens having a significant inclination with respect to the light modules, making it possible to adapt to the esthetics of the motor vehicle comprising the lighting device.

In particular, the lens comprises a first transverse end and a second transverse end, opposite the first transverse end in the substantially horizontal direction, and the first transverse end is located closer to the collector or collectors of the light module or modules than the second transverse end, in the direction of the optical axis of the lighting device.

In particular, the first transverse end is intended to be located on the outer side of the vehicle on which the lighting device is intended to be mounted, and the second transverse end is intended to be located on the inner side of the vehicle on which the lighting device is intended to be mounted.

Advantageously, the collector of the or each light module has a rear edge and the vertical focal point of the lens is located in the vicinity of the rear edge of the or one of the collectors such that the image of this collector formed by the common lens has an upper cut-off formed by the rear edge of this collector.

What is notably meant by a focal point located in the vicinity of the rear edge of a collector is a focal point that is located at a distance of less than 10 mm from said rear edge.

Advantageously, the lighting device comprises a plurality of light modules. Said plurality of light modules comprises two light modules referred to as end light modules, each located at one end of said plurality of light modules in said substantially horizontal direction, the distance between the rear edges of the collectors of said end light modules being less than a predetermined threshold. What is notably meant by a predetermined threshold is a distance of less than 50 mm. It is in fact advantageous for the light modules to be sufficiently close to one another to guarantee that the image of the reflective surface of each collector formed by the common lens is sharp, including for the light modules in which the rear edge of the collector is away from the vertical focal point.

In one embodiment, the device comprises at least one light module, in particular a single light module, extending between the end light modules. In another embodiment, the plurality of light modules is formed by the two end light modules.

In a variant embodiment of the invention, the device comprises a single light module.

In one embodiment, the lighting device herein may be an overall lighting module which comprises at least one light module and which is intended to be mounted in a motor vehicle headlamp.

Advantageously, the horizontal focal point of the lens is located upstream of the lens. In this example, the horizontal focal point of the lens is therefore located upstream of the lens relative to the optical path of the or each light beam reflected by the reflective surface of the or each collector in the direction of the lens.

Advantageously, the lens has, in horizontal section, a biconvex profile. Where appropriate, the lens has, in vertical section, a biconvex profile.

In one particular embodiment of the invention, the horizontal focal point of the common lens is located to the rear of the collector or collectors. The rear of the collector or collectors is defined relative to the overall direction of projection of the light beam or beams. The overall direction of projection corresponds to the direction of the optical path of the light beam or beams.

Advantageously, the common lens is configured to project the or each light beam reflected by the or each collector in an overall direction of projection, and the horizontal focal point of the lens is aligned with the vertical focal point in this overall direction of emission. The alignment of the vertical focal point and the horizontal focal point, in particular with an optical axis of the device, makes it possible to ensure horizontal spreading of the light beam below the cut-off of this light beam, while maintaining a sharp cut-off.

Advantageously, the horizontal focal point of the lens is located to the rear of the collector or collectors and the vertical focal point. The rear of the collector or collectors and the rear of the vertical focal point are defined relative to the overall direction of projection of the light beam or beams. According to this feature, it is possible to spread the projected beam horizontally, and thus to obtain a cut-off which is sharp, including in directions opposite to the inclination of the lens, even in the case of a significant inclination of this lens.

In another embodiment of the invention, the horizontal focal point of the lens is located downstream of the lens. Downstream of the lens is defined with respect to the optical path traveled by the light beam or beams between the or each collector and the lens.

Advantageously, the lens has, in horizontal section, a biconcave profile. Where appropriate, the lens has, in vertical section, a biconvex profile.

Advantageously, the overall light beam projected by the lens from the light beam or beams reflected by the collector of the or each light module forms a light beam of statutory low beam type.

### BRIEF DESCRIPTION OF DRAWINGS

Other advantages and features of the present invention will now be described using examples that are purely illustrative and by no means limit the scope of the invention, and on the basis of the accompanying drawings, in which the various figures show:

FIG. 1 schematically and partially depicts a view from the top of the lighting device according to one embodiment of the invention.

FIG. 2 schematically and partially depicts a view from the top of a lighting device according to another embodiment of the invention.

FIG. 3 schematically and partially depicts a view in cross section of the lighting device according to one embodiment of the invention.

FIG. 4 schematically and partially depicts a view in cross section of the lighting device according to another embodiment of the invention.

In the following description, elements which are identical in structure or in function and appear in various figures keep the same reference sign, unless otherwise stated.

### DETAILED DESCRIPTION OF THE INVENTION

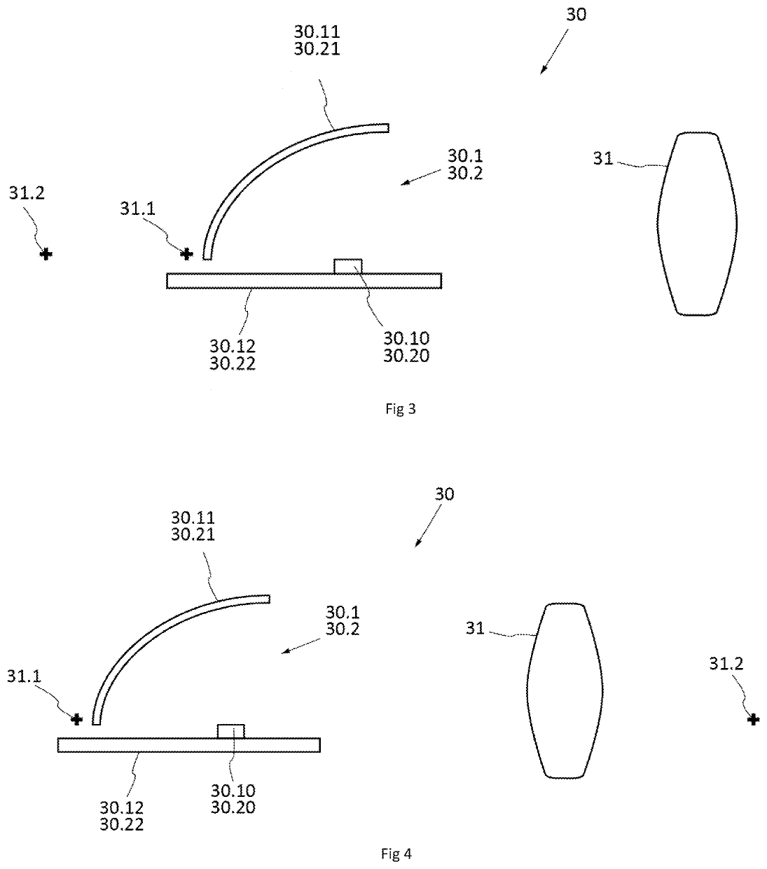

FIG. 1 depicts a motor vehicle lighting device 30 according to one embodiment of the invention. This lighting device 30 will be described in connection with FIG. 3 showing a view in cross section of said embodiment.

The lighting device 30 comprises, for example, two light modules 30.1, 30.2 and, on its front face, an optical projection lens 31. The lens 31 is formed as a single component common to the plurality of light modules 30.1, 30.2, allowing the light beams emitted by the plurality of light sources 30.10, 30.20 to be projected onto the road. The lens 31 is also referred to as the common lens 31.

In FIG. 1, the light modules 30.1, 30.2 are arranged adjacent on the same line and in a substantially horizontal direction, in this case, in such a way as to form a row of light modules. Each of the light modules 30.1, 30.2 comprises at least one light source 30.10, 30.20 and a collector, 30.11, 30.21 respectively, comprising a reflective surface configured to collect and reflect the rays of light emitted by said at least one light source 30.10, 30.20.

Note that the lens 31 extends in a substantially horizontal direction substantially inclined with respect to the light modules 30.1, 30.2, and in particular with respect to the line on which these light modules are arranged. It can thus be seen that the light module 30.1 is closer to the lens 31 than the module 30.2.

In particular, the lens 31 comprises a first transverse end 31a and a second transverse end 31b, opposite the first transverse end 31a in the substantially horizontal direction, and the first transverse end 31a is located closer to the collector 30.11, 30.21 of the light modules 30.1, 30.2 than the second transverse end 31b, in the direction of the optical axis of the lighting device 30.

Each collector 30.11, 30.21 is positioned in such a way that it collects the light beam emitted by the light source 30.10, 30.20 and reflects it toward the lens 31. The collector 30.11, 30.21 of each light module 30.1, 30.2 has a rear edge such that the image of each collector 30.11, 30.21 formed by the common lens 31 has a cut-off, in this case an upper cut-off, formed by the rear edge of each said collector 30.11, 30.21. The common lens 31 is configured to project the light beams emitted by each light source 30.10, 30.20 and reflected by the collectors 30.11, 30.21 in an overall direction of projection.

The lens 31 in this embodiment has, in horizontal section, a biconvex profile and, in vertical section, a biconvex profile. The lens 31 has a vertical focal point 31.1 and a horizontal focal point 31.2. The vertical focal point 31.1 of the common lens 31 is located in the vicinity of the rear edge of the collector 30.11, and in particular at a distance of less than 10 mm from the rear edge of this collector 30.11. The horizontal focal point 31.2 of the common lens 31 is located to the rear of the collectors 30.11, 30.21, and in particular to the rear of the vertical focal point 31.1. The horizontal focal point 31.2 is aligned with the vertical focal point 31.1 and with an optical axis of the device 30. Thanks to this arrangement, the upper cut-off of the image of the reflective surface of the collector 30.11 formed by the lens 31 is sharp.

Furthermore, the two light modules 30.1, 30.2 are arranged in the lighting device 30 in a substantially horizontal direction, such that the distance between their rear edges is less than a predetermined threshold, for example 50 mm. All of the rear edges of the collectors 30.11, 30.21 together define the cut-off of the light beam formed by the device 30, the lens 31 horizontally spreading each of the beams coming from these collectors so that these beams together form, homogeneously, said light beam.

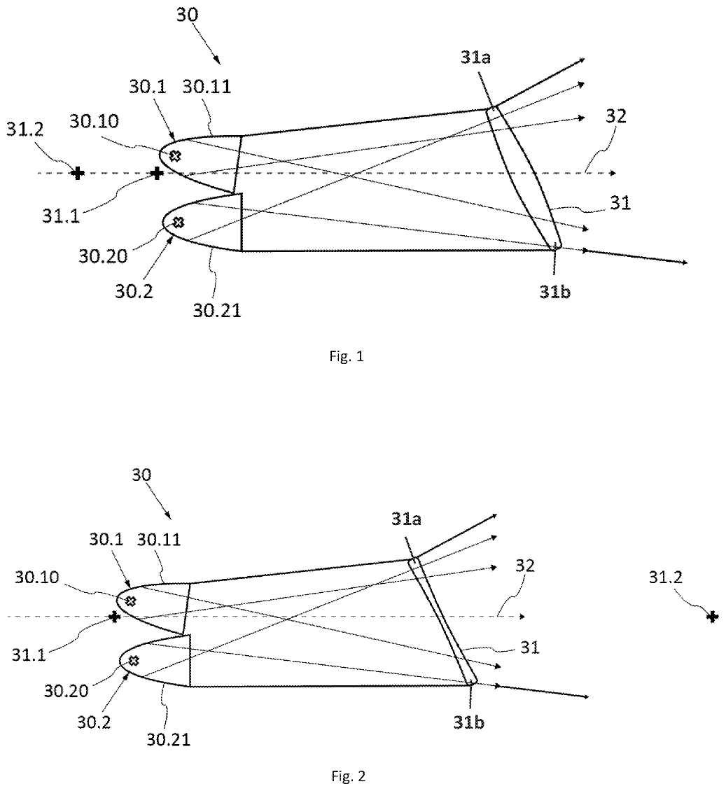

FIG. 2 depicts a motor vehicle lighting device 30 according to another embodiment of the invention. This lighting device 30 will be described in connection with FIG. 4 showing a view in cross section of said other embodiment.

In FIG. 2, the lighting device 30, the light sources 30.1, 30.2 and the collectors 30.11, 30.21 have the same features and the same arrangement as in the previous embodiment.

The lens 31 in this embodiment has, in horizontal section, a biconcave profile and, in vertical section, a biconvex profile. The lens 31 has a vertical focal point 31.1 and a horizontal focal point 31.2. The vertical focal point 31.1 of the common lens 31 is located in the vicinity of the rear edge of one of the collectors 30.1, 30.2.

Owing to the horizontal biconcave shape of the common lens 31, the horizontal focal point 31.2 is located downstream of the common lens 31 relative to the path traveled by the light beams between the collector 30.11, 30.21 and the common lens 31. The horizontal focal point 31.2 is aligned with the vertical focal point 31.1.

The above description clearly explains how the invention makes it possible to achieve its aims, namely to propose a lighting device making it possible to preserve the sharpness of the cut-off formed in a light beam produced by the images of the reflective surfaces of the collector of at least one light module from a lens, including when this lens has a significant inclination with respect to this light module. To this end, the invention proposes a motor vehicle lighting device comprising a common lens having a horizontal focal point and a vertical focal point that are offset with respect to one another.

In any event, the invention should not be regarded as being limited to the embodiments specifically described in this document, and extends, in particular, to any equivalent means and to any technically feasible combination of these means.

What is claimed is:

1. A motor vehicle lighting device for lighting the road, comprising:
at least one light module, with each of the at least one light module including a light source capable of emitting a light beam and a collector with a reflective surface configured to collect and reflect the light beam emitted by the light source;
a lens configured to project the light beam reflected by the collector of each of the at least one light module, the lens being configured to form on the road an image of the reflective surface of the collector of each of the at least one light module; with the lens extending in a substantially horizontal direction, and the substantially horizontal direction being substantially inclined with respect to the light module(s); and
the lens includes a horizontal focal point and a vertical focal point, with the horizontal focal point being offset with respect to the vertical focal point.

2. The motor vehicle lighting device for lighting the road according to claim 1, wherein the collector of each of the at least one light module has a rear edge and wherein the vertical focal point of the lens is located in the vicinity of the rear edge of the collector such that the image of the collector formed by the lens has an upper cut-off formed by the rear edge of the collector.

3. The motor vehicle lighting device for lighting the road according to claim 1, wherein the at least one light module includes two light modules with the two light modules referred to as end light modules, each located at one end of the lighting device in the substantially horizontal direction, and wherein the distance between the rear edges of the collectors of the end light modules is less than a predetermined threshold.

4. The motor vehicle lighting device for lighting the road according to claim 1, wherein the horizontal focal point of the lens is located upstream of the lens.

5. The motor vehicle lighting device for lighting the road according to claim 1, wherein the lens includes a biconvex profile in a horizontal section.

6. The motor vehicle lighting device for lighting the road according to claim 1, wherein the horizontal focal point of the lens is located to the rear of the collector.

7. The motor vehicle lighting device for lighting the road according to claim 1, wherein the lens is configured to project the light beams reflected by the collector in an overall direction of projection, and wherein the horizontal focal point of the lens is aligned with the vertical focal point in this overall direction of emission.

8. The motor vehicle lighting device for lighting the road according to claim 1, wherein the horizontal focal point of the lens is located to the rear of the collector and the vertical focal point.

9. The motor vehicle lighting device for lighting the road according to claim 1, wherein the horizontal focal point of the lens is located downstream of the lens.

10. The motor vehicle lighting device according to claim 1, wherein the lens includes a biconcave profile in a horizontal section.
